(19) United States
(12) Patent Application Publication
(10) Pub. No.: US 2024/0403813 A1
(43) Pub. Date: Dec. 5, 2024

(54) SYSTEM AND METHOD FOR PROVIDING ADAPTIVE COST ANALYSIS FOR A TRANSPORTATION SERVICE

(71) Applicant: Bidspot LLC, Austin, TX (US)

(72) Inventor: Michael Loredo, Austin, TX (US)

(21) Appl. No.: 18/442,048

(22) Filed: Feb. 14, 2024

Related U.S. Application Data
(60) Provisional application No. 63/445,584, filed on Feb. 14, 2023.

(51) Int. Cl. G06Q 10/0834; G06Q 30/0201

(52) U.S. Cl. CPC G06Q 10/08345; G06Q 30/0206

(57) ABSTRACT

A system for adaptive cost analysis for transporting loads is disclosed, the system including at least one user computing device in operable connection with a user network. An application server is in operable communication with the user network to host an application system for providing cost analysis associated with load transportation. The application system includes a user interface module for providing access to the application system through the user computing device. A cost analysis module receives origin and/or destination information and calculates a cost for delivering a load. A mapping module receives origin/destination information associated with one or more loads and displays a map to the user to provide navigational information and cost analysis information for specific loads and/or regions associated with a delivery location.

### CROSS-REFERENCE TO RELATED APPLICATIONS

The present application claims priority to U.S. Provisional Application No. 63/445,584 filed Feb. 14, 2023, titled “SYSTEM AND METHOD FOR PROVIDING ADAPTIVE COST ANALYSIS FOR A TRANSPORTATION SERVICE,” which is hereby incorporated by reference in its entirety.

### TECHNICAL FIELD

The embodiments generally relate to systems and methods for cost analysis for a service and more specifically to systems and methods for providing adaptive cost analysis for transportation services.

### BACKGROUND

The transportation industry relies on logistics and statistics to quote shipping a load having various load parameters to a specific location. In the current arts, broker load board platforms post the quotes which are generated based on market conditions and historical data. Data may include cost per mile, calculated using fuel costs, distance, estimated time needed, etc. This model is often proven inaccurate due to various factors.

Broker platforms often expect carriers and dispatchers to submit a bid to negotiate a contract. Small carriers and new owner operators need to quickly decide on proposed lanes. Thousands of dispatchers/drivers work from the same available public load boards. Seconds may be the deciding factor in moving forward with securing a contract that is acceptable for their business model.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments herein relate to systems and methods for providing adaptive cost analysis for a transportation service. The system includes at least one user computing device in operable connection with a user network. An application server is in operable communication with the user network to host an application system for providing cost analysis associated with load transportation. The application system includes a user interface module for providing access to the application system through the user computing device. A cost analysis module receives origin and/or destination information and calculates a cost for delivering a load. A mapping module receives origin/destination information associated with one or more loads and displays a map to the user to provide navigational information and cost analysis information for specific loads and/or regions associated with a delivery location.

The system allows owner-operators and small carriers to make quick informed decisions on proposed lanes given their cost profile analysis and profit expectations. The system allows cost analysis independent of any specific load board or brokerage platform. Load boards do not take account cost profiles of owner-operators when negotiating bids (there is often a price range decided before negotiations). In such, users have an efficient and accurate means of bidding for loads while accounting for various variable metrics inherent in the transportation industry.

In one aspect, a spot load cost analysis interface receives at least one of the following: a daily drive mile limit, an estimated drive time per week, a target profile, a fuel cost, a driver pay amount, a dispatcher cost amount, and one or more factor fees.

In one aspect, a planner load cost analysis interface permits the user to adapt a cost to load metric.

In one aspect, a cost profile associated with a load is recalled from a database engine comprising one or more of the following: cost categories, baseline costs, and a target bid.

In one aspect, the cost analysis module automatically adjusts the cost to load metric using the total miles divided by the target miles in the load profile.

In one aspect, the cost analysis module automatically adjusts day-specific expenses to account for extra time spent on a load.

In one aspect, the planner load costs analysis interface permits the user to input route information from an origin location using a plurality of GPS information associated with the original location and a destination location.

In one aspect, the planner load costs analysis interface permits the user to add one or more additional routes.

In one aspect, the one or more additional routes are utilized to plan additional loads via the cost analysis module.

In one aspect, a scanner load cost analysis interface permits the user to further adjust the cost to load metric.

In one aspect, a load board interface displays specific load details which include at least one of the following: a rate, an origin location, a delivery location, a distance and a cost per mile.

In one aspect, the load board interface displays a target amount for the load.

In one aspect, the target amount for the load is color coded to indicate if the rate matches, is above, or is below the target bid.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 shows a block diagram of a computing system, according to some embodiments;

FIG. 2 shows a block diagram of a computing system and an application program, according to some embodiments;

FIG. 3 illustrates a screenshot of the information input interface, according to some embodiments;

FIG. 4 illustrates a screenshot of the spot load cost analysis interface, according to some embodiments;

FIG. 5 illustrates a screenshot of the planner load costs analysis interface, according to some embodiments;

FIG. 6 illustrates a screenshot of the scanner load cost analysis interface, according to some embodiments;

FIG. 7 illustrates a screenshot of the load board interface, according to some embodiments;

FIG. 8 illustrates a flowchart of a process for providing cost adaptive analysis for a transportation service;

FIG. 9 illustrates a screenshot of the single load analysis interface, wherein the driver is expected to perform a quoted single load time within a day, according to some embodiments; and

FIG. 10 illustrates a screenshot of the double load analysis interface, wherein the driver is expected to perform a quoted two load times within a day, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before various example embodiments are described in detail, it is noted that the embodiments reside primarily in combinations of components and procedures related to systems. Accordingly, system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be systems, methods, and/or computer program products at any possible technical detail level of integration. A computer program product can include, among other things, a computer-readable storage medium having computer-readable program instructions thereon for causing a processor to carry out aspects of the present disclosure.

In general, the embodiments provided herein relate to systems and methods for providing adaptive cost analysis for transportation services. The system allows owner-operators and small carriers to make a quick informed decisions on proposed lanes given their cost profile analysis and profit expectations. The system allows cost analysis independent of any specific load board or brokerage platform. Load boards do not take account cost profiles of owner-operators when negotiating bids (there is often a price range decided before negotiations). A common model used by owner operators includes the rate per mile model, which falls short when modular inputs are involved such as fuel, driver pay, time to deliver, etc. The embodiments provided herein promote a net estimate model driven by modular inputs which can be used to more efficiently and accurately determine bid pricing that is suitable for each party involved.

In some embodiments, the amounts are not only variable with fuel costs, but also unit extensions of other categories used to calculate the total cost of the load.

As used herein, the term “user” and/or “users” may refer to brokers, owner operators, vehicle operators, drivers, carriers, and any other individual or group associated with the shipping, receiving, dispatchers, and/or transportation of a load.

The embodiments focus on qualifying the broker market rate from the unique cost profile of an owner operator. This includes calculating various load metrics including the time to deliver, driver pay, net profit target, fee percentage, etc. In some embodiments, the time to deliver includes the cost of moving freight during delivery. In some embodiments, driver pay may account for flat rate per load, cost per mile (e.g., cents per mile or other pay scheme). In some embodiments, the net profit target may describe what the final bid price should reflect after all expenses are accounted for (for example, this may be 30% profit margin from expenses or a flat net profit per day driven). In some embodiments, the percentage of fees in the bid price may include other fees often included and known in the transportation industry such as dispatcher pay, lumper pay, etc.

In one example, a load analysis gives a rate of $1000 (net profit $200 is expected) before considering a dispatch fee of 10%. If the model adds a dispatch fee of 10% but should not affect the net $200 profit margin, the rate would be adjusted to $1111 to ask for due to the dispatch rate being $111 to maintain a net profit margin of $200.

In some embodiments, the dispatch fee may be disabled and/or entered as a post-expense.

In some embodiments, the system includes a custom trip planning module configured to calculate a bid for a specific trip associated with transporting a load. Building on the cost model, the user can input city, landmarks, zip codes, and addresses for origin/destination GPS information to provide the final bid quote to meet the expectations of the cost profile along with drive days, drive hours, fuel estimation, and miles driven as a few key factors listed. This is tallied on the user interface (UI) so the user can plan out a chain of loads to see what the estimated costs and bid price goals would be.

In some embodiments, the system includes a closed list trip planning module to calculate a bid (i.e., a cost) associated with a closed trip. In this example, the user can select their current location, city, landmarks, zip codes, and addresses (i.e., transportation metrics) for origin information to provide final bid quotes to closed list cities in various US regions including Pacific, West, Midwest, South, South Atlantic, North Atlantic, etc. In such, the system will calculate a cost based on a region where the load is being transported.

One skilled in the arts will readily understand that while specific examples of destinations are used by way of example, destinations may be defined as specific addresses, cities, and/or regions and are not limited to the United States (i.e., the load may be delivered internationally). Similarly, a radius from a location may be used to calculate the bid (e.g., within 200 miles of Los Angeles).

The embodiments described herein utilize a baseline carrier profile to allow quick crafting of bids that help navigate the market rates in different load boards. This is independent of any load board rates and focuses more on the cost to drive the truck using new key category modular inputs. One skilled in the arts will readily understand that the calculation of a bid may be dependent on variable rates for drivers and may account for various methods of paying the driver. The system may also account for any currently available fuel type, as well as fuel types which may become available in the future. Further, the system may be capable of incorporating additional expense categories, fees, transportation modes, or other factors which adjust the bid which may be presented in the future.

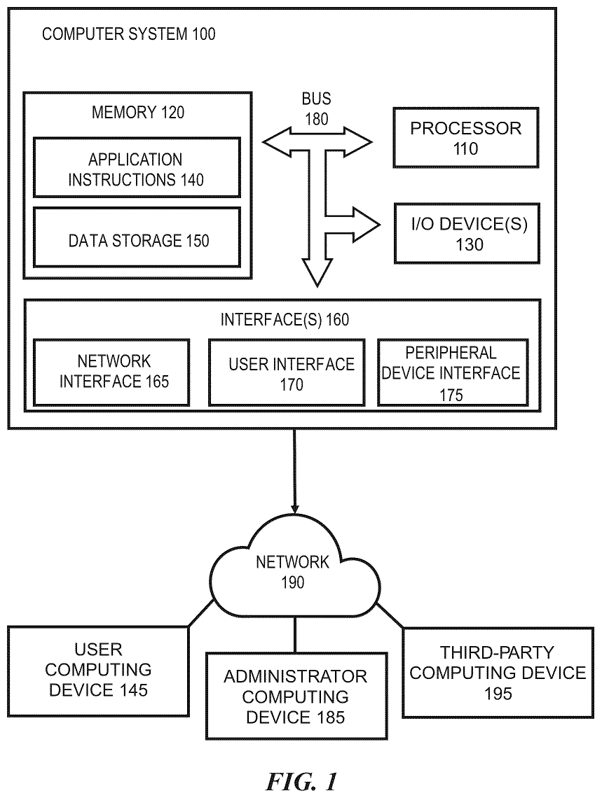

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized a user (e.g., a healthcare provider) to interact with the various functionalities of the system including to perform patient rounds, handoff patient rounding responsibility, perform biometric verification tasks, and other associated tasks and functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

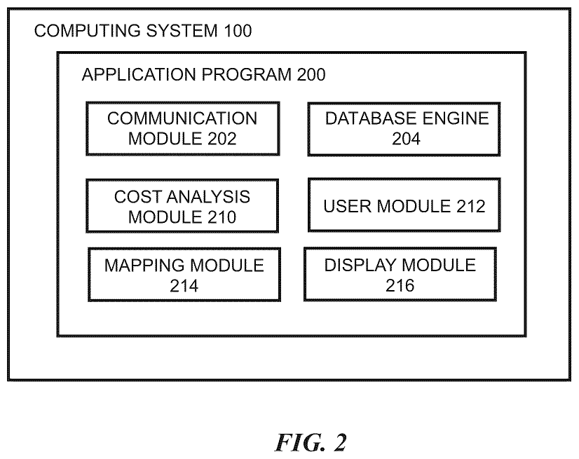

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a matching module 210, a user module 212, an event module 214, and a display module 216.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

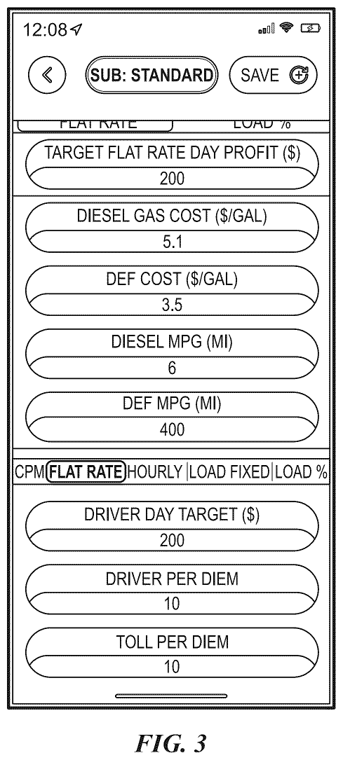

In some embodiments, the cost analysis module 210 is in operable communication with the computing device to receive origin and/or destination information and calculate a cost for delivering a load. The cost analysis module 210 may calculate the cost of delivering the load using various load metrics including origin location, destination location, destination region, total miles, number of loads, the time to deliver, driver pay, net profit target, fee percentage, etc. The process of calculating the cost of delivering one or more loads is further shown and described in FIGS. 3-7 below.

In some embodiments, the user module 212 facilitates the creation of a user account for the application system. The user module 212 may allow the user to create a user profile which includes user information, user fees, preferences, etc.

In some embodiments, the mapping module 214 is in operable communication with the computing device to receive origin/destination information associated with one or more loads and display a map to the user. The map provides navigational information as well as cost analysis information for specific loads and/or regions where loads may be delivered to.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

During use, the user first registers with the application program and user data is transmitted to the computing system and application program thereof. The user may input their daily drive mile limit, estimated drive days (or time) per week, target profit (as a percentage or amount), fuel cost, driver pay, dispatcher cost, factor fees (as a percentage or amount, as well as other costs (e.g., insurance, administrative fees, technology costs, vehicle costs, etc.). This information is input in the information input interface illustrated in FIG. 3.

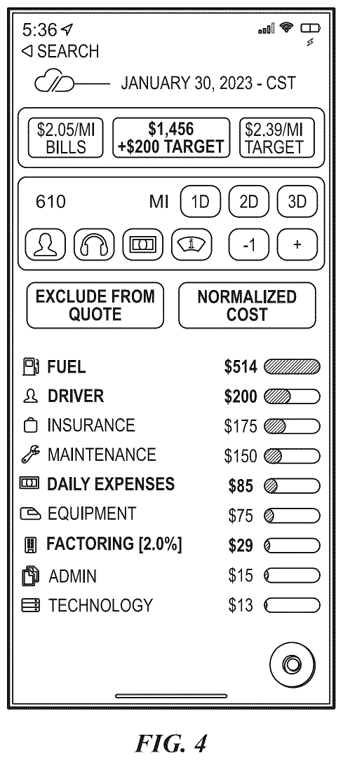

FIG. 4 illustrates a spot load cost analysis interface wherein the user further adapts the cost to load metrics, via the system. A cost profile associate with a load is recalled from the database and cost categories, baseline costs, and target bid prices are displayed. If the load miles are not correct, adjustments to the load miles are made by the user. The system then auto adjusts based on total miles divided by net target miles in the load profile. If the transportation time is expected to take less or more days, adjustments for the cost analysis are controlled by controls on the user interface. Once the adjustments are created for more/less days, the view will adjust any day specific expenses to account for extra time spent on a potential load.

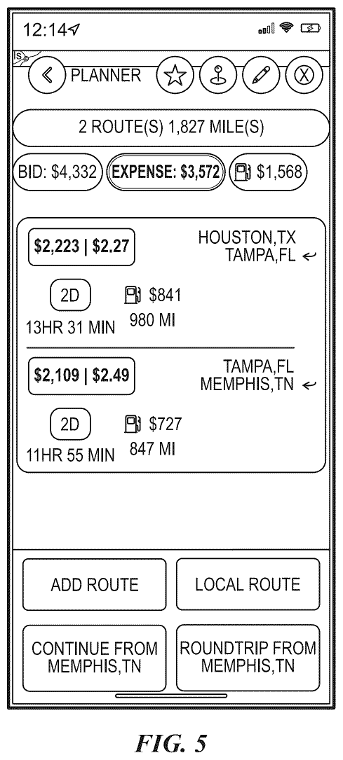

FIG. 5 illustrates a planner load costs analysis interface wherein the user further adapts the cost to load metrics, via the system. Once the user navigates to the planner interface, the user inputs route information for the origin (i.e., the location where the load is to be picked up, or the starting location of the trip) of the load (e.g., zip code, street, landmark, name, city, state, etc.). The user then inputs route information for the destination of the load (i.e., the location where the load is to be delivered). GPS information for the origin location and destination location is transmitted to the mapping module which calculates/determines directions, time to deliver, total miles, etc. The total miles (or other transportation metric) is input into the cost analysis module to provide a bid target and expenses are calculated. The route is then transmitted to a mapping engine which is viewable by the user and/or driver. The user and/or driver may add additional routes to plan a schedule which may include additional loads to calculate, via the cost analysis module, multiple loads which they may choose to transport.

In some embodiments, if the calculated number of days for a load needs to be adjusted to be less or more days, a submenu allows the user to adjust the number of days for the particular route, thus recalculating the total cost.

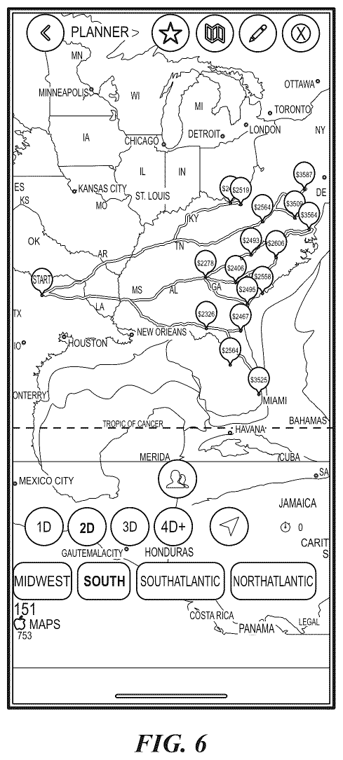

FIG. 6 illustrates a scanner load cost analysis interface wherein the user further adapts the cost to load metrics, via the system. The cost profile is recalled from the database and the user navigates to the scanner interface. The user may then input route information for the origin location (or use a current location). The user may select a repopulated list of destinations based on a region (or a custom list of destinations which has been saved by the user). The GPS system transmits origin and/or destination information to determine directions, time to deliver, total miles, etc. The total miles are input into the cost analysis module to provide a bid target and to calculate expenses. The route is then added to the map, via the mapping module, which can be viewed by the user/driver. The user/driver may then view the map to view bid price targets on locations referenced in the closed set.

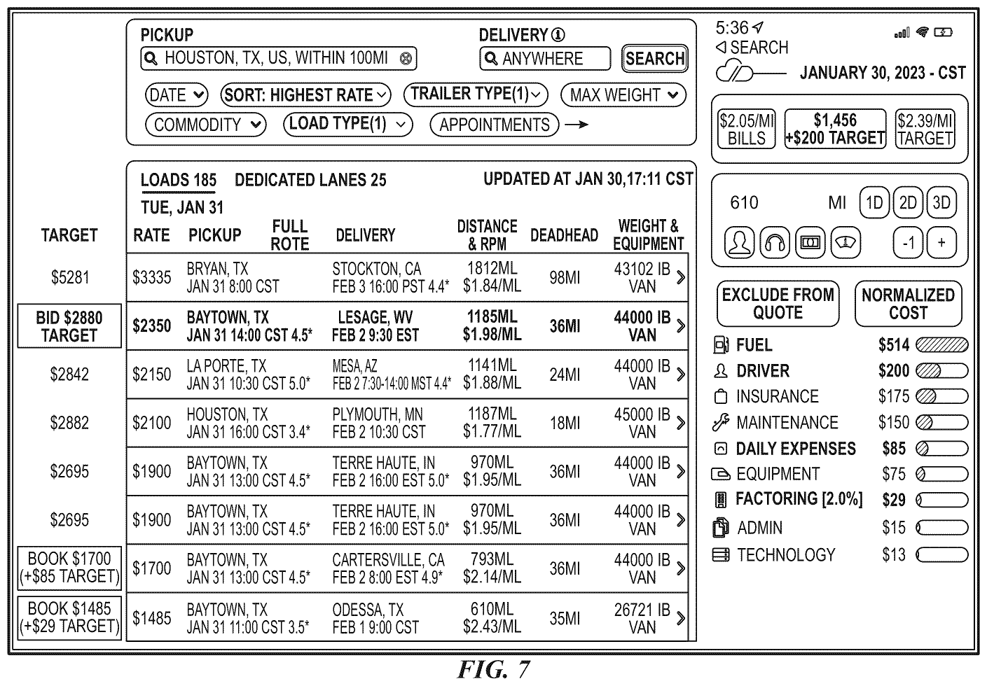

FIG. 7 illustrates a screenshot of the load board interface, wherein the specific load details are displayed including the rate, pickup location, delivery location, distance & cost per mile, among other details of the load. The load board interface may also display a target amount for a load as well as color coding to indicate if the rate matches, is above, or is below the bid target.

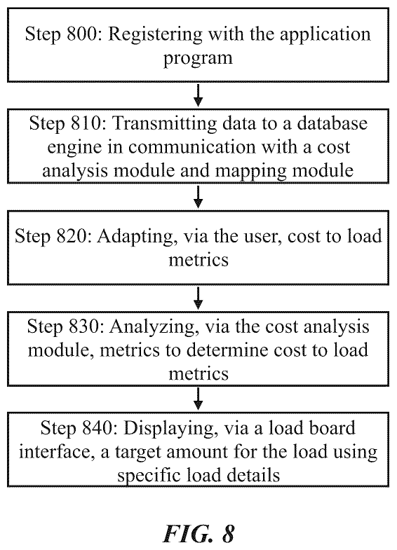

FIG. 8 illustrates a flowchart of a process for providing cost adaptive analysis for a transportation service. In step 800, the user registers for the application program and in step 810, data is transmitted to a database via an application server. The database engine is in communication with the cost analysis module and the mapping module. In step 820, the user adapts the cost to load metrics. In step 830, the cost analysis module analyzes metrics to determine the cost to load metrics and begin establishing a target amount for the load. In step 840, a load board interface displays the target amount for the load using the specific load details. This may be color coded to indicate if the target amount is above, matching, or below the expected target amount.

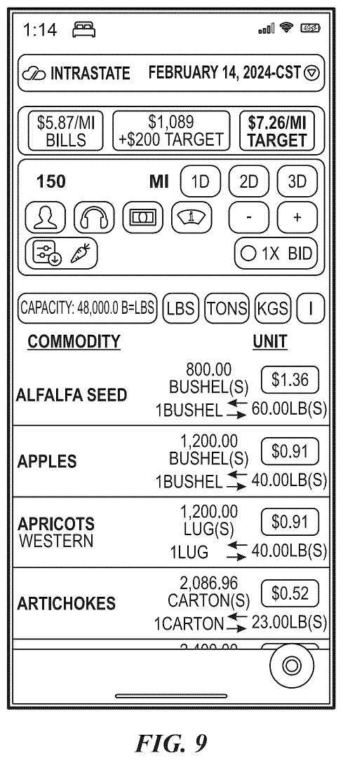

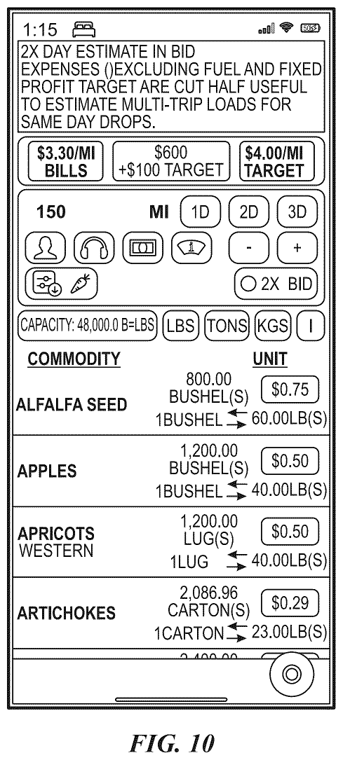

FIG. 9 illustrates a screenshot of the single load analysis interface, wherein the driver is expected to perform a quoted single load time within a day. In the illustrated example, the output conversion for cost per bushel is shown using an equation such as capacity/pounds=bushels. This can be divided into the quote to get the final rate. FIG. 10 illustrates a screenshot of the double load analysis interface, wherein the driver is expected to perform a quoted two load times within a day, according to some embodiments. This interface offers another aspect of variability wherein the driver is expected to perform multiple loads in a single day. Cost limits may be divided by a factor of the number of expected loads in a day where appropriate (in the current example, each aspect except fuel).

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for adaptive cost analysis for transporting loads, the system comprising:
at least one user computing device in operable connection with a user network;
an application server in operable communication with the user network, the application server configured to host an application system for providing cost analysis associated with load transportation, the application system having a user interface module for providing access to the application system through the user computing device;
a cost analysis module to receive origin and/or destination information and calculate a cost for delivering a load; and
a mapping module to receive origin/destination information associated with one or more loads and displays a map to the user, the map to provide navigational information and cost analysis information for specific loads and/or regions associated with a delivery location.

2. The system of claim 1, wherein cost analysis module.

3. The system of claim 1, wherein the mapping module.

4. The system of claim 1, further comprising a spot load cost analysis interface to receive at least one of the following: a daily drive mile limit, an estimated drive time per week, a target profile, a fuel cost, a driver pay amount, a dispatcher cost amount, and one or more factor fees.

5. The system of claim 1, further comprising a planner load cost analysis interface to permit the user to adapt a cost to load metric.

6. The system of claim 5, wherein a cost profile associate with a load is recalled from a database engine comprising one or more of the following: cost categories, baseline costs, and a target bid.

7. The system of claim 6, wherein the cost analysis module automatically adjusts the cost to load metric using the total miles divided by the target miles in the load profile.

8. The system of claim 7, wherein the cost analysis module automatically adjusts day-specific expenses to account for extra time spent on a load.

9. The system of claim 5, wherein the planner load costs analysis interface permits the user to input route information from an origin location using a plurality of GPS information associated with the original location and a destination location.

10. The system of claim 9, wherein the planner load costs analysis interface permits the user to add one or more additional routes.

11. The system of claim 10, wherein the one or more additional routes are utilized to plan additional loads via the cost analysis module.

12. The system of claim 1, further comprising a scanner load cost analysis interface permits the user to further adjust the cost to load metric.

13. The system of claim 1, further comprising a load board interface to display specific load details.

14. The system of claim 13, wherein the specific load details include at least one of the following: a rate, an origin location, a delivery location, a distance and a cost per mile.

15. The system of claim 14, where the load board interface displays a target amount for the load.

16. The system of claim 15, wherein the target amount for the load is color coded to indicate if the rate matches, is above, or is below the target bid.

17. A method for adaptive cost analysis for transporting loads, the method comprising the steps of:
registering, via a user, with the application program;
transmitting, via an application server, a plurality of data to the database engine, the database engine in communication with a cost analysis module and a mapping module;
adapting, via the user, cost to load metrics;
analyzing via the cost analysis module a plurality of metrics to determine a cost to load metric; and
displaying, via a load board interface, a target amount for the load using a plurality of specific load details.

18. The method of claim 17, wherein the target amount is color coded to indicate if the rate matches, is above, or is below the target bid.

19. The method of claim 17, wherein the specific load details including include at least one of the following: a rate, an origin location, a delivery location, a distance and a cost per mile.

20. The method of claim 17, wherein a scanner load cost analysis interface permits the user to further adjust the cost to load metric.
